(19) United States
(12) Patent Application Publication
(10) Pub. No.: US 2006/0018796 A1
(43) Pub. Date: Jan. 26, 2006

(54) Methods and apparatus for preparing multiwell sheets

(76) Inventor: Hans Sitte, San Jose, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/897,158

(22) Filed: Jul. 21, 2004

(51) Int. Cl. B01L 3/02

(52) U.S. Cl. 422/100; 600/382; 422/104

(57) ABSTRACT

Methods, devices and apparatus are disclosed for forming one or more wells in a sheet of deformable material. The device comprises an element comprising a tip adapted for reducing forces on an extruding material and/or preventing resistance to stretch and an outer surface that is at least partially textured and a maximum outside diameter that is less than the diameter of the wells to be formed by at least the thickness of the sheet. In one aspect, the tip is radiused and/or polished. In another aspect, the at least partially textured outer surface is at least adjacent to the radiused tip. The element may be wholly or partially hollow. Apparatus include one or more of the aforementioned devices and a moving mechanism for moving the devices in position for forming one or more wells in a sheet of deformable material.

### BACKGROUND OF THE INVENTION

Aspects of the invention relate to the manufacture of sheets comprising a plurality of wells. More particularly, aspects of the invention relate to extrusion tools for preparing multiwell sheets that may be used, for example, for transferring small quantities of liquids from a multiplicity of depots to a multiplicity of receptacles.

Continuing rapid advances in chemistry, particularly in biochemistry and molecular biology, demand improved capabilities for carrying out large numbers of reactions using small quantities of materials.

Molecular methods using DNA probes, nucleic acid hybridizations and in vitro amplification techniques are promising methods offering advantages to conventional methods used for patient diagnoses, biomedical research or basic biology research. Recent advances in such methods often include the introduction of parallelism, i.e., performing many experiments with the same effort previously used to perform a single experiment. However, the introduction of parallelism often forces changes in the methods used to design such experiments.

Nucleic acid hybridization has been employed for investigating the identity and establishing the presence of nucleic acids. Hybridization is based on complementary base pairing. When complementary single stranded nucleic acids are incubated together, the complementary base sequences pair to form double stranded hybrid molecules. The ability of single stranded deoxyribonucleic acid (ssDNA) or ribonucleic acid (RNA) to form a hydrogen bonded structure with a complementary nucleic acid sequence has been employed as an analytical tool in molecular biology research. The availability of radioactively, chemically and fluorescently labeled nucleoside triphosphates of high specific activity have made it possible to identify, isolate, and characterize various nucleic acid sequences of biological interest. Nucleic acid hybridization has great potential in diagnosing or characterizing diseased or altered tissue function associated with unique nucleic acid sequences or gene expression states. Unique nucleic acid sequences may result from genetic or environmental change in DNA by insertions, deletions, point mutations, or by acquiring foreign DNA or RNA by means of infection by bacteria, molds, fungi, and viruses. Altered gene expression states may arise from neoplastic transformation, viral infection, environmental insult or drug treatment. It is desirable to perform such experiments in parallel.

Enormous and rapidly increasing numbers of critical biomolecules have been identified and characterized, and an understanding of their various roles in cellular processes is vastly improving. Consequently, for example, the number of potential targets for pharmacological intervention is very large. Techniques for parallel chemical synthesis, such as combinatorial chemistries, can efficiently produce libraries of large numbers of synthetic compounds that may be screened against selected targets in a rational drug design approach.

There is significant and growing interest in employing array technologies for conducting biomolecular manipulations. In array techniques certain of the components are immobilized in an array of features on a surface of a solid support and are permitted to interact with other components. Arrays of binding agents, in which such binding agents as oligonucleotides or peptides are deposited onto a support surface in the form of an array, can be useful in a variety of applications, including gene expression analysis, drug screening, nucleic acid sequencing, mutation analysis, and the like. For example, information about the nucleotide sequence of a target nucleic acid may be obtained by contacting the target with an array of different surface-bound DNA probes under conditions that favor hybridization of nucleic acids having complementary sequences, and determining at what sites on the array nucleic acid duplexes are formed. Hybridization to surface-bound DNA probe arrays can provide a relatively large amount of information in a single experiment and, for example, array technology can be useful in differential gene expression analysis.

Considerable effort has been directed to developing better approaches to handling large numbers of samples, reagents and analytes. Automated laboratory workstations and robotics-based systems have been brought to routine use for some chemical manipulations in screening and synthesis, and dedicated computer applications have been developed both for controlling processes and for manipulating data. A number of approaches have been proposed for miniaturizing systems for carrying out chemical processes to reduce the quantities of the various components. Some of these approaches have found use. Particularly, for example, array technologies for binding pair assays use components immobilized in arrays of features on a surface; and microfluidic technologies employ networks of interconnected capillaries to move and combine components on a very small scale.

Whether the miniaturized system is a microfluidic device or an array on a Surface of a substrate, or is of some other design, at least some of the various biomolecules to be introduced to the system are typically prepared in depots remote from the receptacles by which they are introduced to the system. These depots may take the form of a multiwell plate (conventionally providing 96 wells in a 12×8 format), for example, or a microtiter plate (conventionally providing 384 wells in a 16×24 format, or 1536 wells in a 32×48 format). As can be seen, the known techniques employ a step of transferring liquids containing the various biomolecules from depots to receptacles. Manual or automated pipetting systems may be employed to transfer a liquid dropwise from a depot to a receptacle.

In some approaches a flexible material is reversibly deformed to form wells that may be employed to independently contain and deliver small volumes of liquids for various manipulations in the aforementioned array techniques. See, for example, U.S. Pat. No. 6,689,323 (Fisher, et al.), which discloses methods and apparatus for liquid transfer, the disclosure of which is incorporated herein by reference.

There remains a need for development of methods and apparatus for manufacturing sheets comprising a plurality of wells for use in the above procedures for transferring liquids from one container to another or to the surface of a substrate. The methods should provide sheets with wells that are uniform in size and the process should reduce breakage during formation of the wells and provide wells that are resistant to leakage.

### SUMMARY OF THE INVENTION

One embodiment of the present invention is a device for forming one or more wells in a sheet of deformable material. The device comprises an element comprising a tip, the surface features of which are designed to reduce forces on an extruding material and/or to prevent resistance to stretching of the deformable material, an outer surface that is at least partially textured and a maximum outside diameter that is less than the diameter of the wells to be formed by at least the thickness of the sheet. In one aspect, the tip of the device is radiused and/or polished. In another aspect, the at least partially textured outer surface is at least adjacent to the radiused tip. The device element or body may be wholly or partially hollow.

Another embodiment of the present invention is directed to an apparatus comprising one or more devices as described above. In one embodiment the device is secured to a moving mechanism for moving the device in a direction that is substantially normal to the sheet. Where the apparatus comprises more than one device, the devices may be adapted for simultaneous movement or individual independent movement or a combination thereof.

Another embodiment of the present invention is directed to a method for forming wells in a sheet of deformable material. In the method a sheet of material is deformed with the tip of a device as described above to a predetermined depth to form a well in the sheet. Then, the tip of the device is removed from the sheet leaving the formed well. The steps may be repeated to form a plurality of wells in the sheet or a plurality of wells may be formed simultaneously in the sheet.

Another embodiment of the present invention is directed to a method as described above wherein, during and/or following the deforming step, pressure such as, for example, gas pressure, is applied to the sheet through the interior of the device, which may be hollow such as, for example, a tubular device. The pressure may be employed to examine the integrity of the formed well, determine the depth of the well, and so forth.

### BRIEF DESCRIPTION OF THE DRAWINGS

The following figures are included to better illustrate the embodiments of the apparatus and techniques of the present invention. The figures are not to scale and some features may be exaggerated for the purpose of illustrating certain aspects or embodiments of the present invention.

FIG. 1A is a perspective view of a device according to one aspect of the present invention.

FIG. 1B is an enlarged perspective view of a portion of the device of FIG. 1A.

FIG. 2 depicts wells formed in a sheet of material using the device of FIG. 1.

FIG. 3 is a diagram of an apparatus that includes a device of FIG. 1.

FIG. 4 is a block diagram showing summary details of software and hardware for the apparatus of FIG. 3.

FIG. 5A is a cross-sectional view of a portion of an apparatus comprising a plurality of devices (not shown in cross-section) according to one aspect of the present invention as the devices are about to contact a sheet of deformable material.

FIG. 5B is a cross-sectional view of a single device of the apparatus of FIG. 5A showing the formation of a well in a sheet of deformable material at various stages in time.

FIG. 5C is a cross-sectional view of a portion of a sheet of deformable material that comprises a plurality of wells formed therein as depicted in FIGS. 5A and 5B.

FIG. 6A is a perspective view of another embodiment of a device according to one aspect of the present invention.

FIG. 6B is a perspective view of an embodiment of a holder for the device of FIG. 6A.

### DETAILED DESCRIPTION OF SPECIFIC EMBODIMENTS

Embodiments of the present invention may be utilized to manufacture sheets comprising a plurality of wells. Although the primary discussion herein is directed to the use of the wells to contain and transfer biological fluids and reagents associated with biological analyses, the sheets comprising the plurality of wells may be used to contain other reagents or other liquids and to transfer such reagents or other liquids to another location.

One aspect of the invention is a device for forming the aforementioned wells in a sheet of deformable material. The process of forming the wells in the sheet is sometimes referred to herein as an “extrusion process.” The design of the device permits the manufacture of wells that have substantially uniform volume, that have substantially smooth surfaces (e.g., walls and bottoms) and that resist breakage or leakage.

The device comprises an element or a body. In some embodiments the element or body is at least partially or wholly hollow. By this is meant that the hollow portion of the device may extend partially or fully within or through the body or element of the device. In some aspects the element of the device is a tubular element, which may be wholly or partially tubular, that is, the hollow portion of the device may extend partially or fully within the tubular element. Whether partially or wholly hollow, the element may have any cross-sectional shape and the shape of the portion of the element depends on the desired shape of the wells. For example, wells having a generally circular shape may be formed where the device, or at least the portion of the device such as, e.g., the tip portion, that contacts the deformable sheet has a circular cross-sectional shape. The length of the portion of the device that has such a cross-sectional shape is for the most part at least equivalent to the desired depth of the well. The cross-sectional shape of the portion of the element that forms the wells may be other than circular such as, for example, ellipsoid, square, rectangular, triangular and the like again depending on the shape of the well desired. In one embodiment the device comprises a cylindrical tube.

The thickness of the wall of the hollow portion of the element, which is the wall of the portion of the element that is hollow at least along a length of the element that is at least equivalent to the desired depth of the well to be formed, is dependent on factors such as, for example, maintaining structural integrity of at least the hollow portion of the element during the extrusion process and so forth. For the sake of simplicity and convenience of manufacture, the thickness of the wall of the hollow portion of the element may be the same throughout although this is not necessary as discussed above. The thickness of the wall may be about 0.05 to about 0.25 mm, about 0.08 to about 0.24 mm, about 0.12 to about 0.23 mm, about 0.19 to about 0.21 mm, and the like. More precisely, the thickness of the wall may be about 0.0891 to about 0.2410 mm, about 0.1783 to about 0.2282 mm, about 0.1907 to about 0.2158 mm, and so forth. In one embodiment the element is wholly hollow and in one embodiment is a stainless steel tube that is seamless and has a gauge of about 17 to about 19 (which is equivalent to about 0.0575-0.0585 mm to about 0.0415-0.0425 mm), about 18.

The maximum outside diameter of the element of the device is less than the diameter of the well to be formed by at least the thickness of the deformable sheet material. In some embodiments, the maximum outside diameter of the element is less than the diameter of the well to be formed by at least about 1.1, about 1.2, about 1.3, about 1.4, about 1.5, about 1.6, about 1.7, about 1.8, about 1.9, about 2.0, about 2.1, about 2.2, times the thickness of the deformable sheet material. In some embodiments, the maximum outside diameter is less than the diameter of the wells to be formed by about twice the thickness of the sheet of material. The inside diameter of the hollow portion of the element, when the element has a hollow portion, is about 0.05 to about 1.5 mm, about 0.055 to about 1.48 mm, and the like.

The tip of the element or body of the device is designed to reduce forces exerted on the deformable sheet material and to decrease the resistance of the deformable sheet material to deform or to stretch to form the wells (or to decrease surface tangential friction) during the extrusion process. The extent of the reduction of forces exerted on the deformable sheet material is dependent on a number of factors including the nature of the sheet material, the design of the tip of embodiments of the invention, and the like. The extent in the reduction of forces exerted on the deformable sheet material with embodiments of the invention during an extrusion process is at least about 40%, at least about 45%, at least about 50%, at least about 55%, at least about 60%, at least about 65%, at least about 70%, at least about 75%, at least about 80%, at least about 85%, at least about 90%, at least about 95%, at least about 97%. The extent of the decrease in resistance of the deformable sheet material is at least about 40%, at least about 45%, at least about 50%, at least about 55%, at least about 60%, at least about 65%, at least about 70%, at least about 75%, at least about 80%, at least about 85%, at least about 90%, at least about 95%, at least about 97%. The length of the tip portion that should comprise such a design is dependent primarily on the depth of the wells, and so forth. The length of the tip portion that comprises such as design is about 0.08 mm to about 0.12 mm, about 0.09 mm to about 0.11 mm. For a typical well depth of about 3.0 mm, by way of illustration and not limitation, the length of the tip portion comprising such a design is about 2.7 mm. Those skilled in the art will be able to determine such parameters for a particular well depth in view of the teaching herein.

In one approach to achieve the above ends, the tip portion of the element is radiused, which means that the tip has a curvature. The extent of curvature is that which is sufficient to achieve a reduction in forces exerted on the deformable sheet material and a decrease in the resistance of the deformable sheet material to deform or to stretch to form the wells. Such reduction in forces may be measured using methods known in the art and can be measured empirically or modeled. The radius of the curvature may be determined by the following relationship: minimum radius<tip radius<maximum radius where minimum radius is equal to the minimum wall thickness and maximum radius is equal to maximum wall thickness. Potentially, a sharp edge will occur if the radius is much smaller that the wall thickness and too much surface area will be left if the radius is too large. In some embodiments the radius of the tip is equal to the thickness of the wall of the hollow portion of the element at the tip portion divided by about 2 or, in other words, the radius of the tip is about half the thickness of a wall of the hollow portion of the element.

To further achieve the above ends, in some embodiments the tip of the element that is radiused is also polished. The extent of polishing is that which is sufficient to achieve a reduction in forces exerted on the deformable sheet material and a decrease in the resistance of the deformable sheet material to deform or to stretch to form the wells. In some embodiments, the extent of radius, and the extent of polish, of the tip are sufficient to minimize and desirably avoid or eliminate tearing of the sheet during the extrusion process. Consequently, tearing of the sheet during the extrusion process is reduced compared to the level of tearing obtained in the absence of a tip that is radiused and/or polished. Such level of tearing is reduced by at least about 90%, at least about 91%, at least about 92%, at least about 93%, at least about 94%, at least about 95%, at least about 96%, at least about 97%, at least about 98%, at least about 99%, at least about 99.5%. As a result of polishing, the surface of the material, from which the device is fabricated, at the tip is at least about 90%, at least about 91%, at least about 92%, at least about 93%, at least about 94%, at least about 95%, at least about 96%, at least about 97%, at least about 98%, at least about 99%, at least about 99.5% free from coarseness as determined by surface measurements, visual inspection, or other analytical methods known in the art.

The formation of the radiused tip may be achieved by any technique suitable for achieving the desired curvature. Generally, any method that can remove or add surface materials may be used. Such techniques include, for example, grinding, lapping, plasma etching, vapor deposition, and the like. The tip of the element may be polished or smoothed by known techniques such as, for example, buffing with a soft material such as felt, electropolishing, chemical polishing, and the like. In one embodiment, for example, the tip is polished with a buffing wheel and buffing compound. Other means for polishing the tip will be suggested to one skilled in the art.

The device may be fabricated from a material that is consistent with the ability of the device to form the wells in the deformable sheet. The material should have the following characteristics: corrosion resistance (particularly for biological application), sufficient strength for repeated extrusions without needing constant replacement, sufficient rigidity so as to move during the extrusion process, ability to maintain the surface finishes such as polishing and texturing for a large number of extrusions. The material may be, e.g., metal, and the like. The metal may be a pure metal or a metal alloy. Suitable materials include, by way of example and not limitation, stainless steel, brass, hastalloy, platinum, gold, silver, titanium, aluminum, tantalum, tungsten, tantalum-aluminum, and the like; metallized components, e.g., glass, ceramic, plastic and so forth coated with a metal or metal alloy such as gold and the like, and so forth.

The device of the invention may be formed in sections where one of the sections has the characteristics of the element mentioned above and the other section is a holder adapted to receive and hold the element. The holder may be tapered to insert into and frictionally hold the element section of the device. Other forms for the holder section will be apparent to those skilled in the art. Such holders may retain the device by clamping, using a collet of appropriate size, and the like. The holder may have a channel running through all or a portion of the holder for fluid communication with the interior of the element section.

The outer surface of the device is textured at least in an area adjacent the radiused tip. The area of texture is at least from the tip to a point above the length of the device corresponding to substantially the depth of the well. The area of texture may be immediately adjacent to the tip, and in some embodiments may be no more less than the desired well depth and in other embodiments may be about 5 to about 25% more than the well depth. The extent and nature of the texture is that which realizes a reduction in insertion forces of the device into the deformable material and a reduction in adhesion of the deformable material to the device after deformation to form the well. The extent of reduction of adhesion forces desired is approximately proportional to the depth of the texture applied to the surface of the device. By “approximately proportional” is meant that the amount of texturing varies inversely with the adhesion forces. Therefore, the greater the amount of texturing, the lower are the adhesion forces to the extruded material. Furthermore, the extent of texturing may be limited only by the tolerances between the pin, the material, and the die (e.g. a titer plate or the like) and the desired extruded wall texture. Consequently, as the tolerances overall become more strict, more of the pin texturing may appear on the well that is extruded. Generally, any method that removes and/or adds material to the surface and provides a texture to the outer surface of a portion of the element may be used. The texture may be achieved by roughening the surface of the device such as by, for example, mechanical methods, e.g., sanding, grinding, scraping, scoring, sand blasting, glass beading (with glass beads driven by air pressure similar to sandblasting), knurling with appropriate knurling tools and the like. In another approach the outer surface may be knurled such as, for example, by the presence of knobs, ridges, striations, and the like. The knurling is usually uniform over the surface.

One way of approaching the level of texturing is to consider an ANSI (American National Standards Institute) standard. For example, the ANSI B46.1, unified American-British-Canadian Engineering Standard establishes definite classifications for roughness and a set of symbols for documentation (symbol,

$$\sqrt{} ) .$$

For the polished area of the present device in some embodiments,

$$\sqrt[\begin{matrix}4.0 \\ 0.5\end{matrix}]{}$$

may be employed where the 4.0 over the 0.5 indicate 4 to 0.5 micro-inches. For the textured portion of the present device in some embodiments, a minimum

$$\sqrt{\begin{matrix}0.010 \\ ‖ 0.005\end{matrix}}$$

may be employed with the indicating the lay along the length of the tube.

The sheet material that is deformed is generally a flexible material. In some embodiments the sheet of material is reversibly deformable, which means that the material is deformable to the extent necessary to produce a well of desired shape and depth in accordance with the present invention. Depending on the particular application, in some instances the material is substantially irreversibly deformable, which means that the wells remain in substantially the same form prior to, during and after use, i.e., the dimensions of the wells are not substantially altered during this time period. In other instances the material is reversibly deformable, which means that the formed well has and maintains a uniform shape and volume until an external force is applied to urge a bottom and/or a wall of the well inwardly to controllably move liquid out of the well. Such movement of liquid out of a formed well may be realized by controlled application of a force to move liquid in the well to and above the surface of the well as discussed more fully below and in Fisher, et al., supra. The well that is formed in the sheet of deformable material usually has one or more side walls depending on the cross-sectional shape of the well and may have a full or a partial bottom wall. The formed well should not relax to an extent that the dimensions of the formed well are substantially altered upon removal of the present device from the sheet material or placement of liquid therein. Thus, the dimensions are not substantially altered, which means that the dimensions of the well, for example, volume, do not change by more than 0.5%, by more than 0.4%, by more than 0.3%, usually, by no more than 0.1%. Typical volumes for the well are about 2 μL to about 50 μL.

The deformable sheet material has a generally planar shape and is specifically designed for extruding, which means that it will have at least some the following characteristic: elasticity, deformability, puncture resistance and the like. The material for the sheet should be compatible with the type of liquid that will be placed in the formed wells. Accordingly, the material should be inert to such liquids so that it is not dissolved by or reactive with such liquids. Suitable materials may be selected by resort to materials specifications for commercially available membranes, for example, and tested using any desired displacement fluid without undue experimentation. The following materials are listed by way of illustration and not limitation. With the above characteristics in mind, the material may be a latex, silicone rubber, styrene butadiene, polyurethane, polyester, polypropylene, polycarbonate, polyvinyl chloride, polyamide, polyvinylidenedifluoride, polyimides, polycarbonates, polyesters, polyamides, polyethers, polyurethanes, polyfluorocarbons, polystyrenes, poly(acrylonitrile-butadiene-styrene)(ABS), acrylate and acrylic acid polymers such as polymethyl methacrylate, and other substituted and unsubstituted polyolefins, and copolymers thereof and the like; and so forth. Typically, the sheet of material may include a backing layer that permits removable attachment of the sheet to a microtiter plate. Examples of such backing layers include, for example, pressure sensitive adhesives (PSA's), pressure sensitive tapes, films, sprays, and the like. The backing layer may be acrylic or rubber based. Desirably, the backing layer may be removable with minimum use of solvents and/or cleaners so that the microtiter plates or other dies or templates may be reused a numbers of times.

The thickness of the sheet of material depends on the nature of the material, the volume of the well to be formed, the shape of the well to be formed, and so forth. The thickness of the sheet of material also impacts the extrusion speed, which also relates to the throughput of the extrusion system. For example, the sheet of material such as, e.g., a polypropylene material, in which the wells are formed, may have a thickness of about 0.05 to about 0.25 mm, or about 0.10 to about 0.18 mm, or about 0.06 to about 0.08 mm and the like.

The dimensions of the wells vary depending on the particular use of the wells. For the liquids contemplated in microarray technology, the volume is comparable with, or less than (e.g., about up to 75% less than, or about up to 50% less than, or about Up to 25% less than, or a slightly less than) the volume of a standard microtiter plate well. Slightly less than is up to about 10% less than, up to about 5% less than, up to about 3% less than (and so forth) the volume of standard microtiter plate wells. The volume of the wells is about 2 μL to about 50 μL, about 5 μL to about 45 μL, about 10 μL to about 40 μL, about 15 μL to about 35 μL, about 20 μL to about 30 μL. For wells that have a substantially circular cross-sectional dimension, the diameter of the wells is about 50 to about 1500 microns, about 100 to about 1000 microns, about 200 to about 500 microns and the depth is about 5 to about 10,000 microns, about 50 to about 5000 microns, about 100 to about 1000, about 200 to about 300 microns. Wells having a cross-sectional dimension that is other than circular will have dimensions comparable with the above.

The number of wells formed in the sheet is dependent on the number of wells desired for the particular application contemplated. The number of wells may be 1 to about 100,000, about 50 to about 50,000, about 100 to about 10,000. In many embodiments the number of wells corresponds to standard microtiter plates, which may have 96 wells or multiples of 96 wells such as, for example, 192 wells, 384 wells, 1536 wells, 2304 wells, and so forth. Plates with greater numbers of small wells have considerable advantages, including the use of lower amounts of expensive reagents and the greater number of reactions that can be screened on one plate, thus reducing costs and maximizing throughput.

The aforementioned device may further comprise a source of pressure, e.g., gas pressure, and/or a vacuum source communicating with at least the portion of the interior of the element that is adjacent the tip of the element that is used to deform the sheet of material. For such embodiments the interior of at least a portion of the element of the device is hollow to permit fluid communication. The supply of gas to, or removal of gas from, the interior of the element requires fluid communication between the interior and a source of pressure or vacuum. Suitable conduits, connections, valves and the like as are known in the art may be employed. The gas should be inert to the material from which the interior of the element is fabricated and to the sheet material in which the well is formed. The gas should be inert under the conditions of use in the present invention. Such gases include nitrogen, helium, noble gases, and the like, and mixtures thereof. Noble gases include, for example, argon, krypton, xenon, neon, and the like.

The gas may be employed to accomplish at least one or more of the following objectives. The pressure of the gas may be employed to assist in the removal of the tip portion of the device after the sheet has been deformed to form the well. In other words the pressure of the gas may be employed to assist in the separation of the tip portion from portion of the sheet material that has been deformed to form the well. The pressure of the gas necessary to carry out this function is dependent on the sensitivity of the instrumentation and so forth and is usually less that 1 pound per square inch. The pressure of the gas for this purpose may be about 0.25 psi to about 1.5 psi, about 0.5 psi to about 1.25 psi, about 1 psi. In some embodiments, the pressure of the gas necessary to carry out this function is usually less that 1 pound per square inch.

A change in the pressure of the gas may be used to detect when the tip portion of the device contacts the sheet material thereby indicating the start of the process of forming the well. A change in pressure may also be used to determine if the extruded material is intact. To accomplish this function, a pressure transducer is employed in conjunction with the gas pressure. Such pressure transducer may be, for example, Kavlico Pressure Sensors models P163, P168/P168R or similar, Druck model PTX 1240 or similar, Omron E8F2-DN0C or similar, and the like. This aspect of the invention may be explained more fully as follows: The extrusion tube is connected to a gas source and a pressure sensor so that the pressure sensor can detect a change in pressure from the extrusion tube making contact with the extrusion material signifying that the “free” height of the material has been reached and depth “counting” can begin. From this point on during the extrusion process, the pressure sensor is monitored to detect leaks in the well being formed. If any leaks are detected, the process is stopped and an alarm is generated for the defectively processed titer tray. When the desired depth has been reached, the extrusion process is stopped and the extrusion tip direction is reversed. At this time the pressure sensor is used to detect material “bounce back” since the material will “follow” the extrusion tip until all “bounce back” has been relieved. Measuring the distance between the tip reversing and the change in pressure due to the material not following the tip is an “over travel” that can be re-applied to insure that the proper and exact depth has been reached.

A change in pressure or creation of a vacuum may also be used to examine the integrity of the formed well. By integrity of the well is meant the physical integrity, namely, whether there has been a break in the deformed material so liquid placed in the well will leak out of the well. In general, a vacuum is applied to the formed wells and a pressure change is monitored. A vacuum house may be employed together with suitable software for setting a value for leak threshold. Besides appropriate pipes and valves to deliver vacuum, input and output electrical modules and cables are included for signal transmission. Air pressure sensors for measuring vacuum change are also provided as well as suitable power supply devices. In this case the entire bottom of the titer tray is exposed to a vacuum which serves two purposes. The first is a change in vacuum, i.e., a leak, would indicate a broken well; in which case the processing of that titer tray would stop. The second purpose served is that the applied vacuum would also provide an additional force to hold the extruded well in the titer tray and speed up the extrusion process by allowing faster pin removal. The tray is fixed in such a way so that the vacuum source covers the area of interest to be extruded. Inserting the tray into the fixture and applying the initial vacuum would insure the integrity of the un-extruded sheet. During the extrusion process, any detected vacuum leaks might indicate a leak in the well being formed or in one of the previously formed wells or in the as yet untouched portion of the material or might indicate a failure of the adhesion of the sheet to the tray.

Embodiments of the present invention are directed to methods for forming wells in a sheet of deformable material. In the method a sheet of material is deformed with the tip of a device as described above to a predetermined depth to form a well in the sheet. Then, the tip of the device is removed from the sheet leaving the formed well. The steps may be repeated to form a plurality of wells in the sheet. In some embodiments, a plurality of wells may be formed simultaneously in the sheet by employing an apparatus that comprises a plurality of devices as described above. The method is generally carried out at ambient temperature, i.e., the sheet of material to be deformed and the device of the invention are at ambient temperature. This process at ambient temperature is sometimes referred to herein as a “cold-forming process.” In some circumstances or embodiments such as, for example, for biological applications ambient may refer to a clean room environment and perhaps even sterilization of the extrusion tip prior to the extrusion process.

Apparatus

Another embodiment of the present invention concerns an apparatus that comprises the aforementioned device(s). The apparatus should be adapted to move the device(s) relative to sheet of material in which the wells are to be formed. Either the apparatus itself or the individual devices are adapted to allow the device(s) to contact and deform the sheet of material and further to be retracted from the formed well(s).

The phrase “adapted to” or “adapted for” is used herein with respect to components of the present devices and/or apparatus. The components of the present apparatus are adapted to perform a specified function usually by a combination of hardware and software. This includes the structure of the particular component and may also include a microprocessor, embedded real-time software and I/O interface electronics to control a sequence of operations and so forth.

The apparatus may comprise one or more of the above devices secured to a moving mechanism for moving the device in a direction that is substantially normal or perpendicular to the sheet of deformable material. By “substantially normal” is meant that the orientation of the vertical axis of the devices with regard to the horizontal plane of the sheet of material varies from 90 degrees by no more than about one degree.

The number of devices as part of an apparatus is dependent on the number of wells to be formed in one stroke and the number of repetitions desired for the formation of a plurality of wells, economics, and so forth. The apparatus may comprise one, two, three, four, five, six, seven, eight, nine, ten, eleven, twelve, or more devices. Typically, the number of devices will be in even multiples such as, for example, one, two, four, eight, and so forth.

The moving mechanism may be any convenient mechanism for moving one or more of the above devices either independently or simultaneously or a combination thereof. The mechanism may be hydraulic, pneumatic, electromotive, and the like. The moving mechanism may comprise one or more stages to one of which the devices are movably secured to allow for independent movement of the devices. In this approach the apparatus is adapted for independent movement of the plurality of devices. On the other hand, the moving mechanism may comprise one or more stages wherein the devices are affixed to one of the stages where the stage itself is moved to move the devices to the desired location for forming the wells. In this approach the plurality of devices are adapted for simultaneous movement. Combinations of the above may also be employed depending on the circumstances of forming the wells.

The apparatus may include a source of gas to which the elements of the devices are in fluidic communication as described above. The apparatus also includes hardware and software as discussed above for monitoring pressure in the hollow portion of the element particularly in the area adjacent the forming well and also for monitoring changes in gas pressure as discussed above, to control motion of the components of the apparatus including the devices, and so forth. The apparatus may also include a mechanism for controlling the depth of deformation of the sheet material, which may be a vision-based mechanism, encoders connected to the Z-axis and or all axes, stepper motors for the Z axis and/or all axes, “hard” contacts for the Z-axis, or the like. Such mechanism works in conjunction with changes in gas pressure for control of depth of deformation.

In one embodiment by way of illustration and not limitation, the extrusion apparatus comprises a precise servo, or stepper, motor attached to an encoder capable of between about 2 to about 10 times the resolution of the desired extrusion so the desired level of precision can be maintained. The extrusion apparatus is part of an X-Y-Z locating system to provide the proper X and Y location for the Z-axis extrusion apparatus. The precision of the X and Y locating system determines the repeatability of the X and Y spacing of the wells. In this exemplary embodiment of an apparatus, the starting and ending X and Y locations are “taught” to the controller that then calculates the increments for each position (or multiples thereof). Similarly, the top of the extrusion is “taught” to the Z-axis and the depth programmed into the Z-axis controller. The co-ordination of the three axes may be controlled by a programmable logic controller, PLC, or personal computer, PC, or specifically designed application hardware or micro-controller. The word “taught” means that the controller is trained, i.e., the arm, moving member, or the like is positioned in the desired position and the information is stored in the memory of the controller unit as an end position. The training is similar to the way robots are trained, where each position is moved to manually. Then, when the desired position is reached, the information is a stored in memory along with perhaps hundreds of other positions. The robot may then be programmed to perform one or more of multiple functions such as, for example, in this case, to go directly between positions, to move only orthogonally, to perform other predetermined motions between two points, and the like.

Another embodiment of an apparatus by way of example may include an end effector with the ability to detect the top surface of the sheet to be extruded by Such means as an optical, pressure/vacuum, or even a simple gravitational contact switch. An end effector means a device that returns some sensory information back to the controller instead of no information what so ever. Apparatus so equipped may not only be able to determine the top of the sheet but may also be able to overcome material resiliency (reverse stretch) and provide extrusions that are more precise.

Another embodiment by way of example and not limitation uses a simple three axes robot, taught similarly to the X-Y-Z positioning system, and using simple position to determine extrusion depth or any of the previously mentioned end effectors.

The apparatus may also include a source of vacuum such as a vacuum house and the like in fluid communication with the interior of the present device. Also included is suitable software for setting a value for leak threshold. Besides appropriate pipes and valves to deliver vacuum, input and output electrical modules and cables are included for signal transmission. Air pressure sensors for measuring vacuum change are also provided as well as suitable power supply devices.

In one embodiment the apparatus comprises an XYZ stage motion system where the X and Y stages define a horizontal surface and the Z stage defines vertical direction. The present devices are attached to one of the stages of the stage motion system. Movement of the X and Y stages allows location of the areas on the sheet of deformable material where the wells are to be formed. Movement of the Z stage is used to form the wells as discussed above. To calibrate the system and monitor the formation of the wells, a camera based vision system may be employed. The apparatus may include a suitable enclosure to segregate the components of the apparatus from external elements. A computer and/or control system may be used to control motion and electrical I/O systems.

In some embodiments the sheet of material in which the wells are to be formed is placed over a template that has a number of indentations or holes at least corresponding to the number of wells to be formed in the sheet of material. The template is generally fabricated from a rigid substance to provide a structure for supporting the sheet of material during the deformation of the sheet to form the wells. In one approach the template is a microtiter plate with a plurality of wells or a plurality of holes that extend therethrough depending on the manner in which the formed wells are to be used. An article of manufacture is produced wherein a plurality of mixing wells is formed as a unitary sheet of individual mixing wells arranged in rows and columns.

Application of Apparatus

One area of application for embodiments of the present invention is that of preparation or use of arrays of features, which normally comprise a biopolymer. The wells formed in the sheet of material may be utilized to provide samples to droplet dispensing devices commonly used in array manufacture to prepare arrays of features or to droplet dispensing devices for applying samples or reagents to locations on an array of features for analysis of samples.

One application of embodiments of the invention is in a method for synthesizing a plurality of biopolymers at predetermined feature locations on a surface of a substrate. One or more biopolymer subunit precursors are added, in each round of multiple rounds of subunit additions, at each of multiple feature locations on the surface to form the plurality of biopolymers on the surface. Each round of subunit additions may comprise dispensing from a dispensing system the biopolymer subunit precursors to the discrete sites, dispensing activator to the discrete sites, and (c) repeating the above steps.

One particular application is in the liquid transfer procedures discussed in U.S. Pat. No. 6,689,323 (Fisher, et al.), supra. In accordance with the present invention the devices and apparatus described above are employed to prepare the “depot member” as referred to in Fisher, et al., who discloses methods and apparatus for liquid transfer. Liquids are transferred from a plurality of wells or depots having openings arranged in a selected format to one or more receptacles, by displacing liquid contained in each well so that a convex meniscus swells from the opening, and contacting the receptacle with the swollen meniscus to draw a portion of the liquid into the receptacle. According to Fisher, et al., the liquid transfer is effected directly from the depot to the corresponding receptacle without contact between depots and receptacles and without interposition of any transfer device between depots and receptacles. Apparatus for carrying out the method of Fisher, et al., includes a depot member having a plurality of wells having openings supported in a selected format and a receiving member defining at least one receptacle and usually a plurality of receptacles in a corresponding or complementary format; a device for displacing liquid contained within the wells toward and through the openings; and a device for bringing at least one selected well opening into proximity with at least one selected receptacle. In some embodiments of Fisher, et al., the liquid is displaced by inwardly deforming portions of the walls of the wells. The method of Fisher, et al., is particularly useful in transferring multiplicities of liquids from preparative or storage depots to receptacles formed in planar members such as planar microfluidic devices or printing devices adapted for deposition of materials in microarrays.

The sheets comprising wells produced by the apparatus and devices of the present invention, however, may be employed generally as a microstructure in the form of a microtiter plate array, into which chemicals, reagents or other materials are dispensed for the carrying out of reactions of interest to the pharmaceutical and diagnostic industry. A device made by this method may be used for analysis of liquid samples, for the detection of binding events between binding partners, for drug discovery applications and for combinatorial chemistry and other reactions.

The patterns may also be configured for the formation of small reaction chambers or reaction sites/wells in which binding reactions occur, between ligands and their binding partners, which can be monitored. Examples are combinatorial chemistry, binding between proteins and receptors, and binding reactions between RNA/DNA in the sites and complementary gene sequences in solutions. The latter will be applicable to gene mapping and diagnostics.

In another embodiment, the microstructure is a microarray in which DNA/RNA is attached to the array to analyze or sequence the DNA/RNA in a sample. Binding between sample DNA/RNA may be monitored by fluorescence, luminescence or another analysis technique. In another embodiment, the structures contain whole cell monolayers, which are used for assays. The cells are attached by absorption, adsorption, covalently or by another method to surfaces within the device.

By way of general example, a microtiter plate sheet is constructed as described above to form an array of micro-wells. The wells are used for reactions suitable for use in the pharmaceutical or diagnostics industry with reagents dispensed into the wells. The wells are read by any of the methods currently used for the monitoring of reactions 11 the industry, including ELISA, fluorescence binding, luminescence and light scattering.

### Specific Embodiments

Embodiments of the present devices, apparatus and methods are discussed below by way of illustration and not limitation and with reference to the attached drawings.

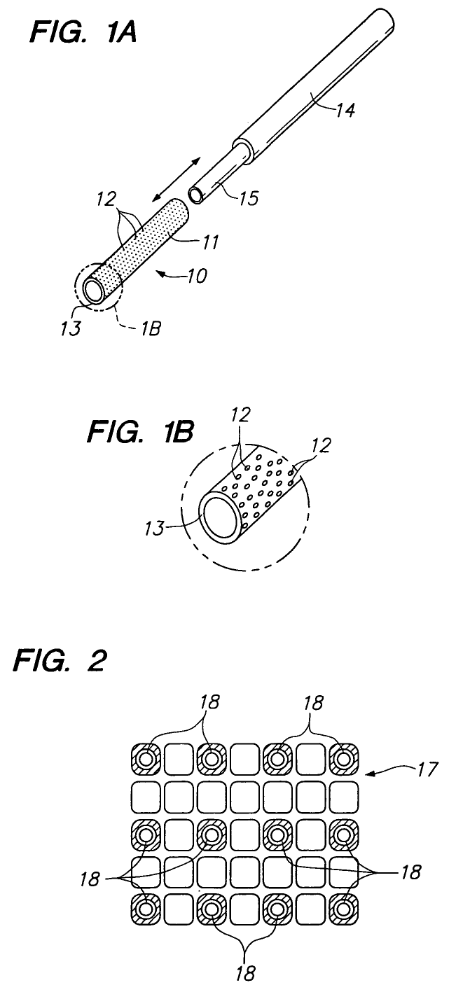

Device 10 is depicted in FIG. 1A and comprises a portion 11, whose surface has been textured 12 by glass beading. The tip 13 of device 10 is radiused and polished. Also depicted is a holder 14 with portion 15 on which portion 11 is removably mounted. Portion 15 is designed to fit into the interior of portion 11, which is held onto holder 14 by clamping, friction fit or the like.

A portion of a sheet 17 of deformable material is shown in FIG. 2 with a plurality of wells 18 that have been formed therein using device 10 depicted in FIG. 1A.

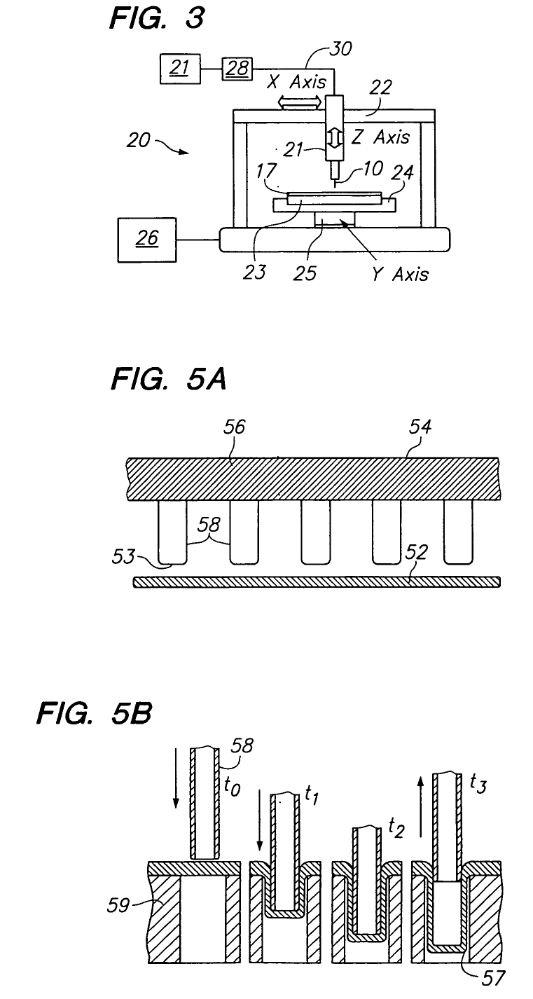

An apparatus 20 is shown in FIG. 3 and comprises device 10 on stage table or holder 21 that forms part of an XYZ stage system and is movable vertically along a Z-axis. The stage system also comprises stage table 22 that is movable horizontally along an X-axis. Sheet 17 of deformable material is supported by microtiter tray 23, which rests on fixture 24 that is part of stage table 25 of the aforementioned XYZ stage system. Stage table 25 is movable horizontally along a Y-axis. Apparatus 20 is controlled by computer 26, which is programmed with suitable software to accomplish the various steps in the method of formation of the wells in the sheet of material. Gas supply 27 is in fluid communication with device 10 by means of appropriate conduits, valves, and the like. Pressure transducer 28 is part of the gas supply system. Computer 26 also controls the function of gas supply 27 and pressure transducer 28 to regulate gas flow and monitoring changes in gas pressure. Computer 26 includes software that monitors gas pressure measurements including changes in gas pressure to calculate and control the depth of the formed well and the starting and ending well position, to detect breakage of the formed well, and so forth. Pressure controller 28 connects via a conduit 30 through holder 21 to device 10. In this embodiment the holder 21 has an interior channel for fluidicly coupling the conduit 30 to the device 10. Accordingly, the pressure controller 28 is fluidicly coupled by the conduit 30 to the interior of device 10. In this way, the controller 28 can send signals to the pressure controller 28 to control selectively a fluid pressure delivered to device 10. Conduit 30 may include appropriate venting for the interior of the holder 21 and device 10.

More detail for the software and hardware is shown in the block diagram of FIG. 4. The hardware should provide (a) movement of a support such as a microtiter tray with a sheet of deformable material affixed over the holes of the microtiter tray, (b) holding the microtiter tray in place, (c) alignment of the system, (d) input and output electrical components, and, optionally, (e) a work cell enclosure for safety and environment control. The software should provide (a) position and speed control for the motion system, (b) electrical signal gathering and processing, (c) monitoring of a manufacturing process through vision system, and database design to hold process parameters and process data collection.

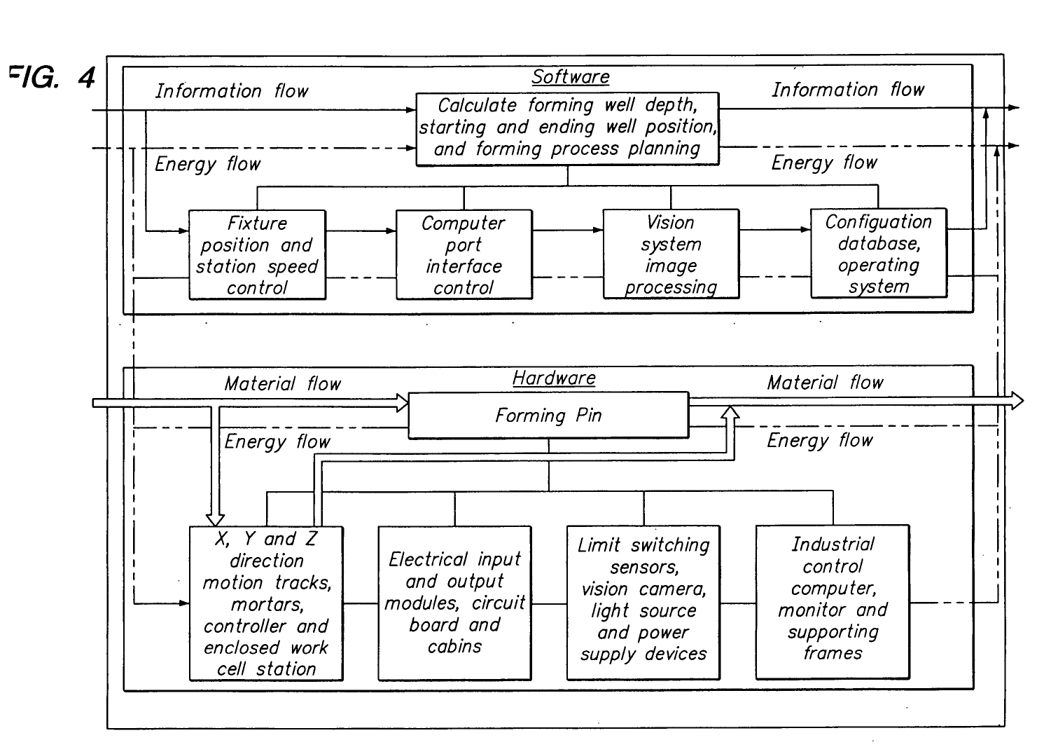

As mentioned above, the devices and apparatus may be used to form wells in a sheet of deformable material. Referring to FIG. 5A, the starting material is a piece of plastic film 52, which is dimensioned to accommodate the desired pattern of depots. An apparatus 54 is provided, consisting of devices 58 projecting from a block member 56. Devices 58 generally are of the form depicted above for device 10. The apparatus 54 is activated to move devices 58 against a surface 53 of the film 52, such that the devices 58 press into and shape the film, as shown in progress in a time sequence (to through t₃) for a single depot in sectional view in FIG. 5B. A die 59, which may be a standard microtiter plate or the like, may be provided to support the film during the cold-forming process. The shaping is continued until the desired shape 50 is complete, as shown in sectional view in FIG. 5C. The desired depth is monitored and controlled by the use of gas pressure supplied through the interior of devices 58 as discussed in more detail above. When the desired depth is reached, the apparatus 54 is then caused to move away from the film, causing the devices 58 to withdraw from the now-shaped depot walls 57, as shown in sectional view in FIG. 5C. The shapes and dimensions of the devices 58 provide the desired shapes for the depots they form; and the positions of the devices 58 on the block member 56 correspond to the desired pattern of the wells. An illustrative example of a completed cold-formed structure appears in FIG. 5C, showing deformable depot walls 57 having-openings 55 onto what remains of the surface 53 of the starting film 52. The deformable walls 57 are by virtue of attenuation during the cold forming process made thinner than the original film 52. Breakage of the well wall is monitored using changes in gas pressure as discussed in more detail above. The desired thickness of the deformable walls 57 can be determined as a matter of design routine; it depends principally upon the characteristics of the particular plastic material used, the dimensions of the deformable wall portion, and the design and construction of the means for deforming the wall. As will be appreciated, the unattenuated portion of the original film that remains among the openings 55 of the deformable walls 57 supports the desired structure 50, and it may be sufficiently rigid to serve as a depot block in the course of the transfer process. However, further support may be required.

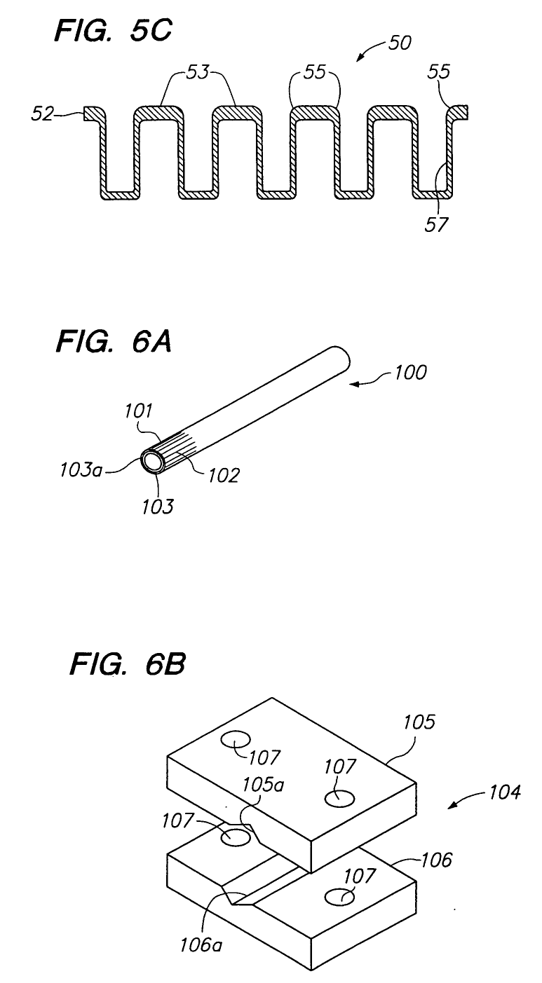

Device 100 is another embodiment of the present invention and is depicted in FIG. 6A and comprises a portion 101, whose surface has been textured 102 by glass beading. The tip 103 of device 100 is radiused 103a and polished. A holder for the device of FIG. 6A is depicted in FIG. 6B. Holder 104 comprises plates 105 and 106. Each of plates 105 and 106 has a groove 105a and 106a, respectively, in which device 100 is secured when plates 105 and 106 are fastened together through holes 107 with machine screws, or other fasteners suitable for the forces of the extrusion material, the extrusion depth, the extrusion speed and so forth.

The aforementioned assembly is based at least in part on robotic principles well known in the art and is just one example of a robotic assembly suitable for moving pin-type device assemblies to locations adjacent a sheet of material. Accordingly, it will be apparent to one of ordinary skill in the art that alternative robotic systems can be practiced with the devices of the invention without departing from the scope thereof.

The devices, apparatus and methods of the invention provide for sheets comprising a plurality of wells that exhibit uniform volume (dimensions, shape). Accordingly, when precise amounts of small quantities of liquid are placed in one or more of the plurality of wells, a significant reduction in well-to-well contamination is realized because of a reduction in the incidences of liquid overflow due to well-to-well irregularities. The apparatus of the invention provide for enhanced speed in the production of the wells as well as less breakage during the formation process when compared to other techniques. Furthermore, well depth may be increased over know methods for well formation. The side walls of the formed wells are smoother, and the bottoms of the formed wells are flatter and more regular, than that for wells produced by other cold-forming techniques.

Terminology Employed above Relating to Biopolymer Applications

A number of terms used in the aforementioned description of specific embodiments of the present invention are defined below.

The term “biomonomer” references a single unit, which can be linked with the same or other biomonomers to form a biopolymer (for example, a single amino acid or nucleotide with two linking groups one or both of which may have removable protecting groups). A reagent fluid or biomonomer fluid or biopolymer fluid refers to a liquid containing either a biomonomer or biopolymer, respectively (typically in solution).

The term “biopolymer” refers to a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions.

The term “polynucleotide” or “nucleic acid” refers to a compound or composition that is a polymeric nucleotide or nucleic acid polymer. The polynucleotide may be a natural compound or a synthetic compound. The polynucleotide can have from about 2 to 5,000,000 or more nucleotides. The larger polynucleotides are generally found in the natural state. In an isolated state the polynucleotide can have about 10 to 50,000 or more nucleotides, usually about 100 to 20,000 nucleotides. It is thus obvious that isolation of a polynucleotide from the natural state often results in fragmentation. It may be useful to fragment longer target nucleic acid sequences, particularly RNA, prior to hybridization to reduce competing intramolecular structures.

The polynucleotides include nucleic acids, and fragments thereof, from any source in purified or unpurified form including DNA (dsDNA and ssDNA) and RNA, including tRNA, mRNA, rRNA, mitochondrial DNA and RNA, chloroplast DNA and RNA, DNA/RNA hybrids, or mixtures thereof, genes, chromosomes, plasmids, cosmids, the genomes of biological material such as microorganisms, e.g., bacteria, yeasts, phage, chromosomes, viruses, viroids, molds, fungi, plants, animals, humans, and the like. The polynucleotide can be only a minor fraction of a complex mixture such as a biological sample. Also included are genes, such as hemoglobin gene for sickle-cell anemia, cystic fibrosis gene, oncogenes, cDNA, and the like.

The polynucleotide can be obtained from various biological materials by procedures well known in the art. The polynucleotide, where appropriate, may be cleaved to obtain a fragment that contains a target nucleotide sequence, for example, by shearing or by treatment with a restriction endonuclease or other site-specific chemical cleavage method.

The nucleic acids may be generated by in vitro replication and/or amplification methods such as the Polymerase Chain Reaction (PCR), asymmetric PCR, the Ligase Chain Reaction (LCR), transcriptional amplification by an RNA polymerase, and so forth. The nucleic acids may be either single-stranded or double-stranded. Single-stranded nucleic acids are preferred because they lack complementary strands that compete for the oligonucleotide probes during the hybridization step of the method of the invention. A nucleic acid may be treated to render it denatured or single stranded by treatments that are well known in the art and include, for instance, heat or alkali treatment, or enzymatic digestion of one strand.

The term “oligonucleotide” refers to a polynucleotide, usually single stranded, either a synthetic polynucleotide or a naturally occurring polynucleotide. The length of an oligonucleotide is generally governed by the particular role thereof, such as, for example, probe, primer, predictor and the like. Various techniques can be employed for preparing an oligonucleotide. Such oligonucleotides can be obtained by biological synthesis or by chemical synthesis. For short oligonucleotides (up to about 100 nucleotides), chemical synthesis will frequently be more economical as compared to biological synthesis. In addition to economy, chemical synthesis provides a convenient way of incorporating low molecular weight compounds and/or modified bases during specific synthesis steps. Furthermore, chemical synthesis is very flexible in the choice of length and region of the target polynucleotide binding sequence. The oligonucleotide can be synthesized by standard methods such as those used in commercial automated nucleic acid synthesizers. Chemical synthesis of DNA on a suitably modified glass or resin can result in DNA covalently attached to the surface. This may offer advantages in washing and sample handling. Methods of oligonucleotide synthesis Include phosphotriester and phosphodiester methods (Narang, ET al. (1979) Meth. Enzymol 68:90) and synthesis on a support (Beaucage, et al. (1981) Tetrahedron Letters 22:1859-1862) as well as phosphoramidite techniques (Caruthers, M. H., et al., “Methods in Enzymology,” Vol. 154, pp. 287-314 (1988)) and others described in “Synthesis and Applications of DNA and RNA,” S. A. Narang, editor, Academic Press, New York, 1987, and the references contained therein.

Oligonucleotides may be employed, for example, as oligonucleotide probes or primers. The term “oligonucleotide probe” refers to an oligonucleotide employed to bind to a portion of a polynucleotide such as another oligonucleotide or a target nucleotide sequence. The design, including the length, and the preparation of the oligonucleotide probes are generally dependent upon the sequence to which they bind and their function in the methods of the invention.

The phrase “nucleoside triphosphates” refers to nucleosides having a 5′-triphosphate substituent. The nucleosides are pentose sugar derivatives of nitrogenous bases of either purine or pyrimidine derivation, covalently bonded to the 1′-carbon of the pentose sugar, which is usually a deoxyribose or a ribose. The purine bases include adenine (A), guanine (G), inosine (I), and derivatives and analogs thereof. The pyrimidine bases include cytosine (C), thymine (T), uracil (U), and derivatives and analogs thereof. Nucleoside triphosphates include deoxyribonucleoside triphosphates such as the four common deoxyribonucleoside triphosphates dATP, dCTP, dGTP and dTTP and ribonucleoside triphosphates such as the four common triphosphates rATP, rCTP, rGTP and rUTP. The term “nucleoside triphosphates” also includes derivatives and analogs thereof, which are exemplified by those derivatives that are recognized and polymerized in a similar manner to the underivatized nucleoside triphosphates.

The term “nucleotide” or “nucleotide base” or “base” refers to a base-sugar-phosphate combination that is the monomeric unit of nucleic acid polymers, i.e., DNA and RNA. The term as used herein includes modified nucleotides. In general, the term refers to any compound containing a cyclic furanoside-type sugar (β-D-ribose in RNA and β-D-2′-deoxyribose in DNA), which is phosphorylated at the 5′ position and has either a purine or pyrimidine-type base attached at the C-1′ sugar position via a α-glycosol C1′-N linkage. The nucleotide may be natural or synthetic.

The phrase “biopolymer subunit precursor” refers to a reactive biopolymer subunit that can add to a growing chain of biopolymer subunits. The reactive biopolymer subunit comprises one or more sites of activation depending on the nature of the biopolymer subunit and the synthetic route utilized to prepare the biopolymer. The phrase “nucleotide precursor” refers to a reactive unit that can add to a growing chain of nucleotides. For example, the nucleotide precursor may be a phosphoramidite nucleotide reagent or the like.

The term “DNA” refers to deoxyribonucleic acid.

The term “RNA” refers to ribonucleic acid.

The term “nucleoside” refers to a base-sugar combination or a nucleotide lacking a phosphate moiety.

The terms “hybridization (hybridizing)” and “binding” in the context of nucleotide sequences are used interchangeably herein. The ability of two nucleotide sequences to hybridize with each other is based on the degree of complementarity of the two nucleotide sequences, which in turn is based on the fraction of matched complementary nucleotide pairs. The more nucleotides in a given sequence that are complementary to another sequence, the more stringent the conditions can be for hybridization and the more specific will be the binding of the two sequences. Increased stringency is achieved by elevating the temperature, increasing the ratio of co-solvents, lowering the salt concentration, and the like.

The term “complementary,” “complement,” or “complementary nucleic acid sequence” refers to the nucleic acid strand that is related to the base sequence in another nucleic acid strand by the Watson-Crick base-pairing rules. In general, two sequences are complementary when the sequence of one can bind to the sequence of the other in an anti-parallel sense wherein the 3′-end of each sequence binds to the 5′-end of the other sequence and each A, T(U), G, and C of one sequence is then aligned with a T(U), A, C, and G, respectively, of the other sequence. RNA sequences can also include complementary G/U or U/G basepairs.

The term “hybrid” refers to a double-stranded nucleic acid molecule formed by hydrogen bonding between complementary nucleotides. The term “hybridize” refers to the process by which single strands of nucleic acid sequences form double-helical segments through hydrogen bonding between complementary nucleotides.

The term “substrate” or “support” refers to a porous or non-porous water insoluble material, on a surface of which one or more arrays are present. Typically, the substrate material is transparent. By “transparent” is meant that the substrate material permits signal from features on the surface of the substrate to pass therethrough without substantial attenuation and also permits any interrogating radiation to pass therethrough without substantial attenuation. By “without substantial attenuation” may include, for example, without a loss of more than 40% or more preferably without a loss of more than 30%, 20% or 10%, of signal. The interrogating radiation and signal may for example be visible, ultraviolet or infrared light. In certain embodiments, such as for example where production of binding pair arrays for use in research and related applications is desired, the materials from which the substrate may be fabricated should ideally exhibit a low level of non-specific binding during hybridization events.

The materials for the substrate may be naturally occurring or synthetic or modified naturally occurring. Suitable rigid substrates may include glass, which term is used to include silica, and include, for example, glass such as glass available as Bioglass, and suitable plastics. Should a front array location be used, additional rigid, non-transparent materials may be considered, such as silicon, mirrored surfaces, laminates, ceramics, opaque plastics, such as, for example, polymers such as, e.g., poly (vinyl chloride), polyacrylamide, polyacrylate, polyethylene, polypropylene, poly(4-methylbutene), polystyrene, polymethacrylate, poly(ethylene terephthalate), nylon, poly(vinyl butyrate), etc., either used by themselves or in conjunction with other materials. The surface of the substrate is usually the outer portion of a substrate.

The surface of the material onto which the biopolymers are formed may be smooth or substantially planar, or have irregularities, such as depressions or elevations. The surface may be modified with one or more different layers of compounds that serve to modify the properties of the surface in a desirable manner. Such modification layers, when present, will generally range in thickness from a monomolecular thickness to about 1 mm, usually from a monomolecular thickness to about 0.1 mm and more usually from a monomolecular thickness to about 0.001 mm. Modification layers of interest include: inorganic and organic layers such as metals, metal oxides, polymers, small organic molecules and the like. Polymeric layers of interest include layers of: peptides, proteins, polynucleic acids or mimetics thereof (for example, peptide nucleic acids and the like); polysaccharides, phospholipids, polyurethanes, polyesters, polycarbonates, polyureas, polyamides, polyethylene amines, polyarylene sulfides, polysiloxanes, polyimides, polyacetates, and the like, where the polymers may be hetero- or homo-polymeric, and may or may not have separate functional moieties attached thereto (for example, conjugated). Various further modifications to the particular embodiments described above are, of course, possible. Accordingly, the present invention is not limited to the particular embodiments described in detail above.

The material used for an array support or substrate may take any of a variety of configurations ranging from simple to complex. Usually, the material is relatively planar such as, for example, a slide. In many embodiments, the material is shaped generally as a rectangular solid. As mentioned above, multiple arrays of chemical compounds may be synthesized on a sheet, which is then diced, i.e., cut by breaking along score lines, into single array substrates. Typically, the substrate has a length in the range about 5 mm to 100 cm, usually about 10 mm to 25 cm, more usually about 10 mm to 15 cm, and a width in the range about 4 mm to 25 cm, usually about 4 mm to 10 cm and more usually about 5 mm to 5 cm. The substrate may have a thickness of less than 1 cm, or even less than 5 mm, 2 mm, 1 mm, or in some embodiments even less than 0.5 mm or 0.2 mm. The thickness of the substrate is about 0.01 mm to 5.0 mm, usually from about 0.1 mm to 2 mm and more usually from about 0.2 to 1 mm. The substrate is usually cut into individual test pieces, which may be the size of a standard size microscope slide, usually about 3 inches in length and 1 inch in width.

Binding of oligonucleotides to a surface of a substrate may be accomplished by well-known techniques, commonly available in the literature. See, for example, A. C. Pease, et al., Proc. Nat. Acad. Sci. USA, 91:5022-5026 (1994).

“Methods for detecting nucleic acids” generally employ nucleic acid probes that have sequences complementary to sequences in the target nucleic acid. A nucleic acid probe may be, or may be capable of being, labeled with a reporter group or may be, or may be capable of becoming, bound to a support. Detection of signal depends upon the nature of the label or reporter group. Usually, the probe is comprised of natural nucleotides such as ribonucleotides and deoxyribonucleotides and their derivatives although unnatural nucleotide mimetics such as peptide nucleic acids and oligomeric nucleoside phosphonates are also used. Commonly, binding of the probes to the target is detected by means of a label incorporated into the probe. Alternatively, the probe may be unlabeled and the target nucleic acid labeled. Binding can be detected by separating the bound probe or target from the free probe or target and detecting the label. In one approach, a sandwich is formed comprised of one probe, which may be labeled, the target and a probe that is or can become bound to a surface. Alternatively, binding can be detected by a change in the signal-producing properties of the label upon binding, such as a change in the emission efficiency of a fluorescent or chemiluminescent label. This permits detection to be carried out without a separation step. Finally, binding can be detected by labeling the target, allowing the target to hybridize to a surface-bound probe, washing away the unbound target and detecting the labeled target that remains.

The term “drop” or “droplet” refers to a small amount of liquid traveling in a space, and while often approximately spherical if no external forces are acting upon it, may have other shapes depending upon those other forces. A drop that has contacted a substrate is often referred to as a deposited drop, although sometimes it will be simply referenced as a drop when it is understood that it was previously deposited.

The phrase “droplet dispensing device” includes any device that dispenses drops of fluid, usually, a liquid. The droplet dispensing device normally includes a reagent source or manifold or reservoir as well as reagent lines that connect the source to fluid dispensing nozzles and the like. The “reservoir” may be any container that is suitable for containing a fluid reagent.

The phrase “pulse jet” refers to a device that can dispense drops by delivering a pulse of pressure (such as by a piezoelectric or thermoelectric element) to liquid adjacent an outlet or orifice such that a drop will be dispensed therefrom.

An “array” includes any one-, two- or three-dimensional arrangement of addressable regions bearing a particular feature such as a biopolymer, e.g., polynucleotides, associated with that region. An array is addressable in that it has multiple regions of different moieties, for example, different polynucleotide sequences, such that a region or feature or spot of the array at a particular predetermined location or address on the array can detect a particular target molecule or class of target molecules although a feature may incidentally detect non-target molecules of that feature.

An array assembly on the surface of a substrate refers to one or more arrays disposed along a surface of an individual substrate and separated by inter-array areas. Normally, the surface of the substrate opposite the surface with the arrays (opposing surface) does not carry any arrays. The arrays can be designed for testing against any type of sample, whether a trial sample, a reference sample, a combination of the foregoing, or a known mixture of components such as polynucleotides, proteins, polysaccharides and the like (in which case the arrays may be composed of features carrying unknown sequences to be evaluated). The surface of the substrate may carry at least one, two, four, or at least ten, arrays. Depending upon intended use, any or all of the arrays may be the same or different from one another and each may contain multiple spots or features of chemical compounds such as, e.g., biopolymers in the form of polynucleotides or other biopolymer. A typical array may contain more than ten, more than one hundred, more than one thousand or ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges.

Any of a variety of geometries of arrays on a substrate may be used. As mentioned above, an individual substrate may contain a single array or multiple arrays. Features of the array may be arranged in rectilinear rows and columns. This is particularly attractive for single arrays on a substrate. When multiple arrays are present, such arrays can be arranged, for example, in a sequence of curvilinear rows across the substrate surface (for instance, a sequence of concentric circles or semi-circles of spots), and the like. Similarly, the pattern of features may be varied from the rectilinear rows and columns of spots to include, for example, a sequence of curvilinear rows across the substrate surface (for example, a sequence of concentric circles or semi-circles of spots), and the like. The configuration of the arrays and their features may be selected according to manufacturing, handling, and use considerations.

Each feature, or element, within the molecular array is defined to be a small, regularly shaped region of the surface of the substrate. The features are arranged in a predetermined manner. Each feature of an array usually carries a predetermined biopolymer or mixtures thereof. Each feature within the molecular array may contain a different molecular species, and the molecular species within a given feature may differ from the molecular species within the remaining features of the molecular array. Some or all of the features may be of different compositions. Each array may contain multiple spots or features and each array may be separated by spaces or areas. It will also be appreciated that there need not be any space separating arrays from one another. Interarray areas and interfeature areas are usually present but are not essential. The interarray and interfeature areas do not carry any polynucleotide (or other biopolymer of a type of which the features are composed). Interarray areas and interfeature areas typically will be present where arrays are formed by the conventional in situ process by depositing for each feature at least one droplet of reagent such as from a pulse jet. It will be appreciated though, that the interarray areas and interfeature areas, when present, could be of various sizes and configurations.

The term “complementary” refers to two sequences where the sequence of one can bind to the sequence of the other in an anti-parallel sense wherein the 3′-end of each sequence binds to the 5′-end of the other sequence and each A, T(U), G, and C of one sequence is then aligned with a T(U), A, C, and G, respectively, of the other sequence. RNA sequences can also include complementary G=U or U=G basepairs.

The term “label” refers to a member of a signal producing system. Usually the label is part of a target nucleotide sequence or an oligonucleotide probe, either being conjugated thereto or otherwise bound thereto or associated therewith. The label is capable of being detected directly or indirectly.

All publications and patent applications cited in this specification are herein incorporated by reference as if each individual publication or patent application where specifically and individually indicated to be incorporated by reference.

Although embodiments of the foregoing invention have been described in some detail by way of illustration and example for purposes of clarity of understanding, it will be readily apparent to those of ordinary skill in the art in light of the teachings of this invention that changes and modifications may be made thereto without departing from the spirit or scope of the appended claims. Furthermore, the foregoing description, for purposes of explanation, used specific nomenclature to provide a thorough understanding of the invention. However, it will be appreciated that one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. A device for forming wells in a sheet of deformable material, said device comprising an element comprising a tip, an outer surface that is textured at least adjacent said tip and a maximum outside diameter that is less than the diameter of the wells to be formed by at least the thickness of the sheet.

2. A device according to claim 1 wherein said tip is radiused and/or polished and the extent of radius and the extent of polish of said tip is sufficient to minimize tearing of said sheet.

3. A device according to claim 2 wherein said element comprises a hollow portion adjacent said tip and the radius of said tip is about half the thickness of a wall of said hollow portion.

4. A device according to claim 1 wherein said maximum outside diameter is less than the diameter of the wells to be formed by about twice the thickness of the sheet.

5. A device according to claim 1 further comprising a pressure source communicating with the interior of said element.

6. A device according to claim 5 wherein said pressure source is a gas pressure source.

7. An apparatus comprising a device according to claim 1.

8. An apparatus according to claim 7 wherein said device is secured to a moving mechanism for moving said device in a direction that is substantially normal to said sheet.

9. An apparatus according to claim 8 wherein said moving mechanism is hydraulic, pneumatic or electromotive.

10. An apparatus according to claim 7 comprising a plurality of said devices.

11. An apparatus according to claim 10 wherein said plurality of devices are adapted for simultaneous movement.

12. An apparatus according to claim 10 wherein said plurality of devices are adapted for independent movement.

13. A method for forming wells in a sheet of deformable material, said method comprising:
(a) deforming said sheet with the tip of a device according to claim 1 to form a well in said sheet and
(b) removing said tip of said device from said sheet.

14. A method according to claim 13 wherein said sheet is deformed to a predetermined depth.

15. A method according to claim 13 wherein steps (a) and (b) are repeated to form a plurality of wells in said sheet.

16. A method according to claim 13 wherein said sheet is deformed simultaneously to form a plurality of wells using a plurality of said devices.

17. A method according to claim 13 wherein prior to step (a) said sheet is placed over a plate having a plurality of wells therein.

18. A method according to claim 13 wherein said deformable material is a plastic material.

19. A method according to claim 13 wherein pressure or vacuum is applied to said sheet through the interior of said element.

20. A method according to claim 19 wherein gas pressure is applied and said gas pressure is employed to detect contact of said tip of said device with said sheet to determine the beginning of the deforming.

21. A method according to claim 19 wherein gas pressure is applied and said gas pressure is employed to signal a predetermined depth of said deforming.
